(19) United States
(12) Patent Application Publication
(10) Pub. No.: US 2001/0047388 A1
(43) Pub. Date: Nov. 29, 2001

(54) Electronic mail system

(75) Inventors: Hidefumi Kondo, Osaka (JP); Eiichiro Ito, Osaka (JP); Joji Uemura, Osaka (JP); Takahiro Yanagihara, Osaka (JP); Takeo Yamamoto, Osaka (JP); Yasuhiro Tsuchiya, Osaka (JP)

Correspondence Address: HELFGOTT & KARAS, P.C., 60th Floor, Empire State Building, New York, NY, 10118, US

(73) Assignee: Fujitsu Limited

(21) Appl. No.: 09/754,783

(22) Filed: Jan. 4, 2001

(30) Foreign Application Priority Data
May 23, 2000 (JP) 2000-152063

(51) Int. Cl. G06F 15/16

(52) U.S. Cl. 709/206; 709/246

(57) ABSTRACT

An electronic mail system is provided that can control suppression of a transmission band and a storage area of a mail, and can communicate all contents of a mail transmitted from a sender to a receiver. The electronic mail system is provided with a transmission apparatus (1) and a reception apparatus (2). The transmission apparatus (1), when transmitting a mail A with a signature added, transmits a mail A′ whose size is made smaller by converting the signature to a signature ID. The mail A′ is held in a mail server 4 through a mail server 3. The receipt apparatus 2, when receiving the mail A′ from the mail server 4, restores the mail A by converting the signature ID in the mail A′ to the signature.

### BACKGROUND OF THE INVENTION

1. Field of the Invention

The present invention relates to an electronic mail system, more particularly to a system for transmitting and receiving electronic mails.

2. Description of the Related Art

With the rapid penetration of the internet in recent years, the number of users of electronic mails are increasing. FIG. 12 is a view explaining a general structure of an electronic mail (hereinafter referred to simply as “a mail”). In FIG. 12, the mail consists of a mail header given by a protocol of an electronic mail (SMTP), a mail text describing an affair between parties concerned, and a signature indicating a name of a sender, a place of contact and the like. A signature is generally written at the end of a mail text. FIG. 13 is a view showing an example of duplication (a redundant part) of mail information. As shown in FIG. 13, when three mails are received from a same sender, mail headers and mail texts have different contents respectively, but signatures have no difference at all in most cases. This is, in other words, “duplication or redundancy of data”. Originally, a signature is for writing out information for identifying an individual, and does not have a characteristic that it is changed for every transmission. Sending a mail with data such as a signature whose contents are rarely changed is a cause for suppressing a transmission band or a storage area of a storage apparatus such as a hard disk.

Recently, individuals have more chances of utilizing mails such as at home, in addition to business utilization in companies by expansion of the internet. Thus, there is a tendency that “individuality” is attempted to be expressed in a signature. For example, in many cases, signatures include indications such as invitation of hobby friends and recent news of families, or decorations using character codes specifically for visual attraction. FIG. 14 is a view explaining an example of a signature part added with an illustration that is drawn utilizing characters. In addition, FIG. 15 is a view explaining examples of a signature part added with “an animation logo” of a company name or images of GIF, JPEG and the like. In this way, a data amount of a signature tends to increase, and which becomes “a data amount of a mail text <<a data amount of a signature part” in many cases. Even if a ratio of a data amount of a mail text to a data amount of a signature is moderately estimated as “a data amount of a mail text:a data amount of a signature part=7:1”, 12.50% of a transmission band and 12.50% of a hard disk of a mail server and the like are found, by simple calculation, to be wasted for transmission and storage of signature data. However, since the significance of existence of a signature is increasing, a signature cannot be easily simplified.

As one means for decreasing the size of an electronic mail, there is, for example, a method disclosed in the Japanese Patent Application No. Hei 8-173544. The method assumes a utilization form in which data is transmitted over a narrow band such as one for radio, and contents of an electronic mail is partly omitted. However, since this method deletes a part of an electronic mail, all pieces of the information from a sender does not necessarily reach a receiver of the mail, therefore this is not a reliable information communication from the sender to the receiver.

In addition, as a method for automatically extracting a signature part of character strings from a file of electronic mails, there is a method for supporting update of address book and device therefor disclosed, for example, in the Japanese Patent Application Laid-open No. Hei 10-171827.

### SUMMARY OF THE INVENTION

The present invention has been devised in view of the above drawbacks and it is an object of the present invention to provide an electronic mail system that can control suppression of a transmission band and a storage area for a mail, and can communicate to a receiver all contents of a mail transmitted from a sender.

The present invention adopts the following configuration in order to solve the above-mentioned problems. That is, the present invention is an electronic mail system that is provided with a transmission apparatus and a reception apparatus. The transmission apparatus includes first storing means for holding a signature of an electronic mail by associating it with identification information; identification information reading out means for reading out from the first storing means identification information corresponding to a signature included in an electronic mail to be transmitted; converting means for converting the signature of the electronic mail to the identification information read out by the identification information reading out means; and transmitting means for transmitting the electronic mail with its signature part being converted to the identification information by the converting means to its destination. The reception apparatus includes second storing means for holding a signature of an electronic mail by associating it with identification information; receiving means for receiving an electronic mail transmitted from the transmission apparatus; signature reading out means for reading out from the second storing means a signature corresponding to the identification information included in the electronic mail received by the receiving means; and restoring means for converting the identification information included in the electronic mail to the signature read out by the signature reading out means.

In accordance with the present invention, a signature in a mail is converted to identification information by the transmission apparatus and is transmitted to the reception apparatus. The identification information is formed such that its data size is smaller than that of the signature itself. Thus, suppression of a transmission band of a mail or a storage area of a storage apparatus of a mail server that relays the mail can be controlled when the mail is transmitted from the transmission apparatus to the reception apparatus. Thereafter, when the mail is received by the reception apparatus, the identification information is converted to the signature. In this way, the mail is restored to the state in which the mail includes the original signature. Therefore, the mail including all pieces of information transmitted for a sender can be given to a receiver.

The present invention can take a configuration in which the first storing means and the second storing means can hold a signature and identification information corresponding to the signature by associating them with a sender's mail address of an electronic mail.

In addition, the present invention can take a configuration in which the transmission apparatus further includes extracting means for, when contents held by the first storing means are renewed, extracting information concerning the renewal as renewal information, and transmits the renewal information, and the reception apparatus further includes renewing means for, when the receiving means receives the abo e renewal information, renewing contents held by the second storing means in accordance with the renewal information. With this configuration, the contents stored in the first storing means and the second storing means can be synchronized, and identification information may be converted to a signature in the reception apparatus.

The present invention may be configured such that the transmitting means transmits an electronic mail having renewal information including a signature registered anew in the first storing means and identification information allocated to this signature, and the renewing means renews contents held by the second storing means in accordance with the renewal information included in the electronic mail received by the receiving means. In this case, the electronic mail may be an electronic mail for renewing the contents of the second storing means, or may be an electronic mail added with a signature registered anew in the first storing means and identification information corresponding to the signature to be transmitted to the reception apparatus.

In addition, the present invention can be specified as a transmission apparatus that is provided with storing means for holding a signature of an electronic mail by associating it with identification information; identification information reading out means for reading out from the storing means identification information corresponding to a signature included in an electronic mail to be transmitted; converting means for converting the signature of the electronic mail to the identification information read out by the identification information reading out means; and transmitting means for transmitting the electronic mail with its signature part being converted to the identification information by the converting means to its destination.

In addition, the present invention can be specified as a reception apparatus of an electronic mail that is provided with storing means for holding a signature of an electronic mail by associating it with identification information; receiving means for receiving an electronic mail transmitted by the transmission apparatus; signature reading out means for, if identification information of a signature is included in the electronic mail received by the receiving means, reading out a signature corresponding to the identification information from the above-mentioned storing means; and restoring means for converting the identification information included in the electronic mail to the signature read out by the signature reading out means.

The transmission apparatus is, for example, a computer functioning as a mail client, or a computer functioning as a mail server. The reception apparatus is, for example, a computer functioning as a mail client, or a computer functioning as a mail server.

Both the transmission apparatus and the reception apparatus may be mail clients or mail servers. In addition, the transmission apparatus may be a mail client that transmits a mail, and the reception apparatus may be a mail server. Further, the transmission apparatus may be a mail server that relays a mail, and the reception apparatus may be a mail client that receives a mail.

In accordance with an electronic mail system of the present invention, suppression of a transmission band and a storage area of a mail can be controlled, and all contents of a mail transmitted from a sender can be communicated to a receiver.

### BRIEF DESCRIPTION OF THE DRAWINGS

Other objects and advantages of the present invention will become apparent during the following discussion in conjunction with the accompanying drawings, in which:

FIG. 1 is a schematic illustration of an example of a configuration of an electronic mail system in accordance with the present invention;

FIG. 2 is a flow chart describing operations of a transmitting side (a transmission apparatus) of an electronic mail;

FIG. 3 is an explanatory view of the operations of the transmitting side of an electronic mail;

FIG. 4 is a flow chart describing operations of a receiving side (a reception apparatus) of an electronic mail;

FIG. 5 is an explanatory view of the operations of the receiving side of an electronic mail;

FIG. 6 is a flow chart describing operations of a transmitting side (a transmission apparatus) in a first synchronization processing;

FIG. 7 is a flow chart describing operations of a receiving side (a reception apparatus) in the first synchronization processing;

FIG. 8 is an explanatory view of the operations of the first synchronization processing;

FIG. 9 is a flow chart describing the operations of the transmitting side (the transmission apparatus) in the second synchronization processing;

FIG. 10 is a flow chart describing the operations of the receiving side (the reception apparatus) in the second synchronization processing;

FIG. 11 is an explanatory view of the operations of the second synchronization processing;

FIG. 12 is an explanatory view of a conventional art;

FIG. 13 is an explanatory view of a conventional art;

FIG. 14 is an explanatory view of a conventional art; and

FIG. 15 is an explanatory view of a conventional art.

### DETAILED DESCRIPTION OF THE PREFERRED EMBODIMENT

Embodiments of the present invention will now be described with reference to the drawings.

<Configuration>

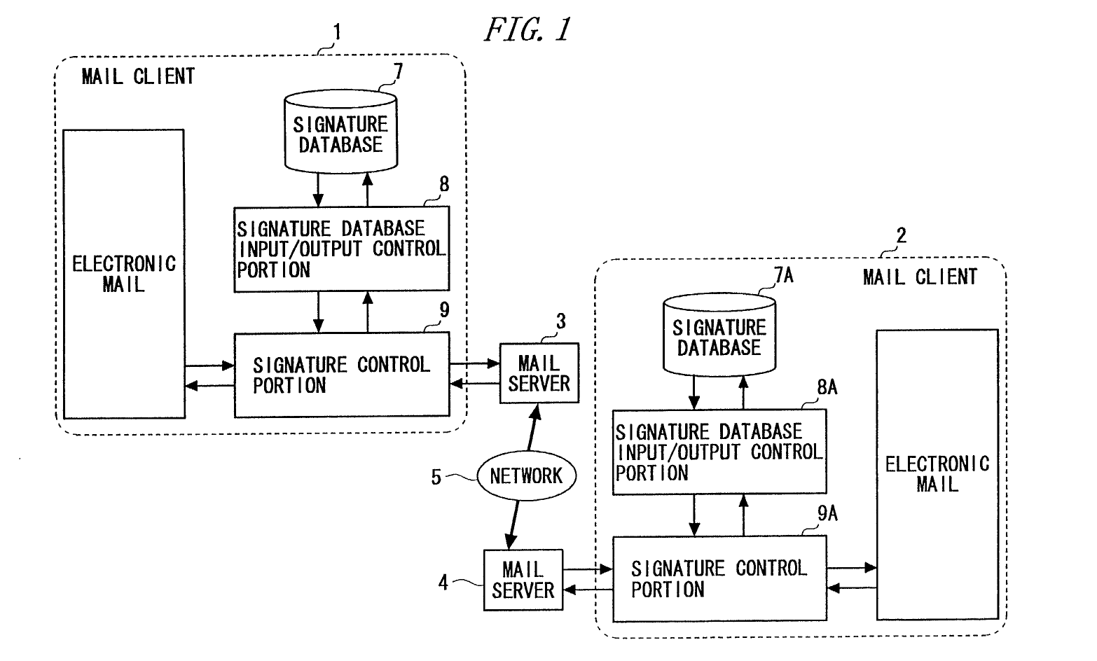

FIG. 1 is a schematic illustration of an example of a configuration of an electronic mail system in accordance with an embodiment of the present invention. In FIG. 1, an electronic mail system has a mail client 1 and a mail client 2. The mail client 1 is connected to a mail server 3, the mail client 2 is connected to a mail server 4, and the mail server 3 and the mail server 4 are connected each other via a network 5.

Each of the mail clients 1 and 2 has the same configuration, and is configured using a computer that is provided with a processor apparatus such as a CPU, a main memory, a recording medium such as a hard disk, a communication interface and the like, whereas the computer is connected to an input apparatus such as a keyboard and a pointing device, an output apparatus such as a display apparatus and a printer. The computer is, for example, a personal computer, a work station, and a Personal Digital Assistance (PDA).

In each of the mail clients 1 and 2, the processor apparatus loads and executes various kinds of programs held in the storage medium. In this way, as shown in FIG. 1, the mail client 1 functions as an apparatus that is provided with a signature database (hereinafter referred to as “the DB”) 7, a signature database input/output control portion (hereinafter referred to as “the input/output control portion”) 8 and a signature control portion (hereinafter referred to as “a control portion”) 9, and the mail client 2 functions as an apparatus that is provided with a DB 7A, an input/output control portion 8A and a control portion 9A.

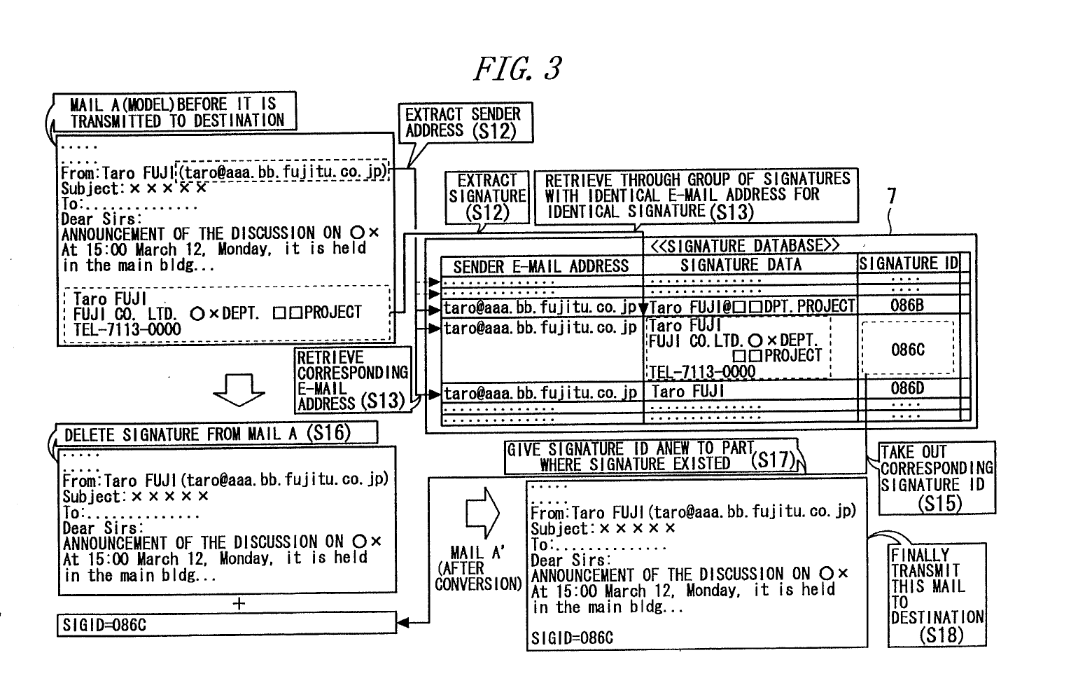

Each of the DBs 7 and 7A is a database for accumulating information concerning a signature of a mail. In this embodiment, as shown in FIG. 3, a management table of information concerning a signature is accumulated in a database format. That is, each of the DBs 7 and 7A accumulates in the management table a record including an electronic mail address of a sender of a mail (hereinafter referred to as “a sender address”), data of a signature part in the mail (signature data) and a signature ID (SIGID) as identification information of the signature.

The signature ID is a specific code of a signature consisting of a predetermined character string (in this example, four half-size characters), and is a unique code with respect to a sender address and a signature data. The signature ID is formed such that its data size is smaller than that of the signature itself.

Each of the input/output control portions 8 and 8A accesses the DB 7 or the DB 7A, and controls reading out processing of data from the DB 7 or the DB 7A and writing processing of data in the DB 7. Each of the control portions 9 and 9A executes confirmation of contents of a prepared electronic mail before transmitting the electronic mail to the mail server. At this time, each of the control portions 9 and 9A executes watching processing of the signature ID, automatic generation processing of an electronic mail for synchronization with the DB 7 and the DB 7A and so on.

<Operational Examples>

Operational examples of the electronic mail system shown in FIG. 1 will now be described. Here, the case in which the mail client 1 functions as a transmission apparatus and the mail client 2 functions as a receipt apparatus to send a mail from the mail client 1 to the mail client 2 will be described.

[Procedures in a Transmitting Side]

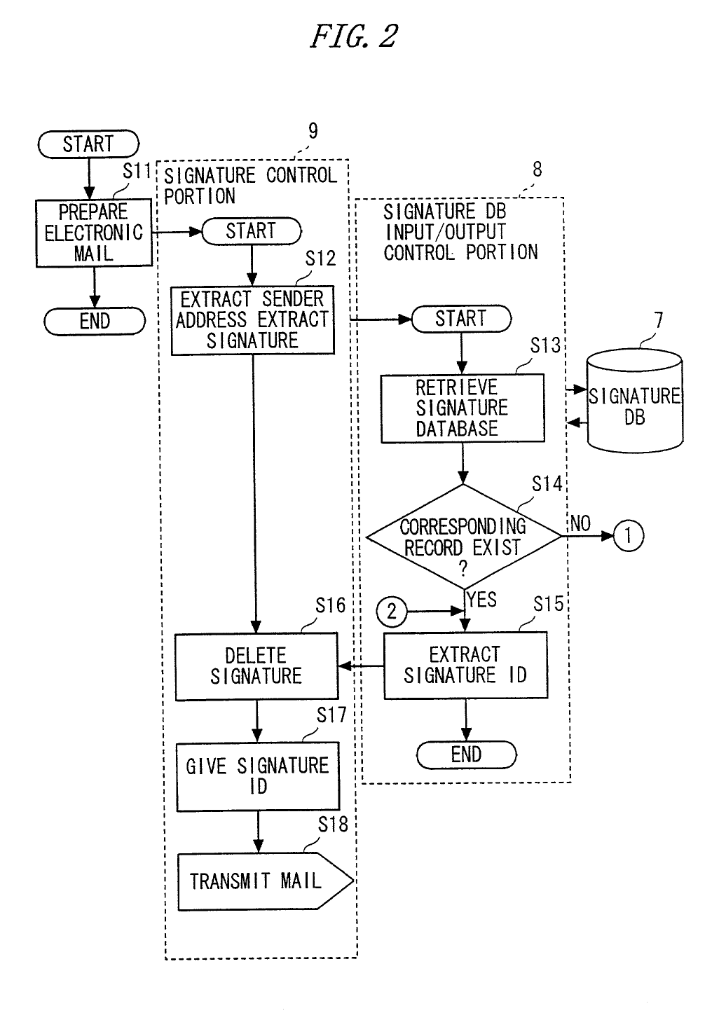

Procedures in a transmitting side will be described with reference to FIGS. 2 and 3. FIG. 2 is a flow chart describing operations in the transmitting side (in this example, the mail client 1), and FIG. 3 is an explanatory view of operations of the transmitting side.

First, a user of the mail client 1 (a sender of a mail) prepares a mail A to be transmitted (S11). That is, the user prepares a mail text with a signature added, and designates an electronic mail address of a transmission destination of the mail (hereinafter referred to as “a transmission destination address”) Here, a mail address of a user of the mail client 2 (receiver) is designated. Thereafter, when the preparation of the mail A is completed, the user inputs a transmission instruction of the mail.

Then, the control portion 9 is activated, and extracts a sender address of the mail (for example, “taro@aaa.bb.fujitsu.co.jp”) as well as a signature (signature data) from the prepared mail A (S12). The control portion 9 transfers the extracted sender address and the signature data to the input/output control portion 8.

Then, the input/output control portion 8 is activated, and retrieves through the DB 7 using the sender address and the signature data <corresponding to the first storing means>. That is, the input/output control portion 8 retrieves through the DB 7 a record with the identical sender address, and further retrieves a record with the identical signature (S13).

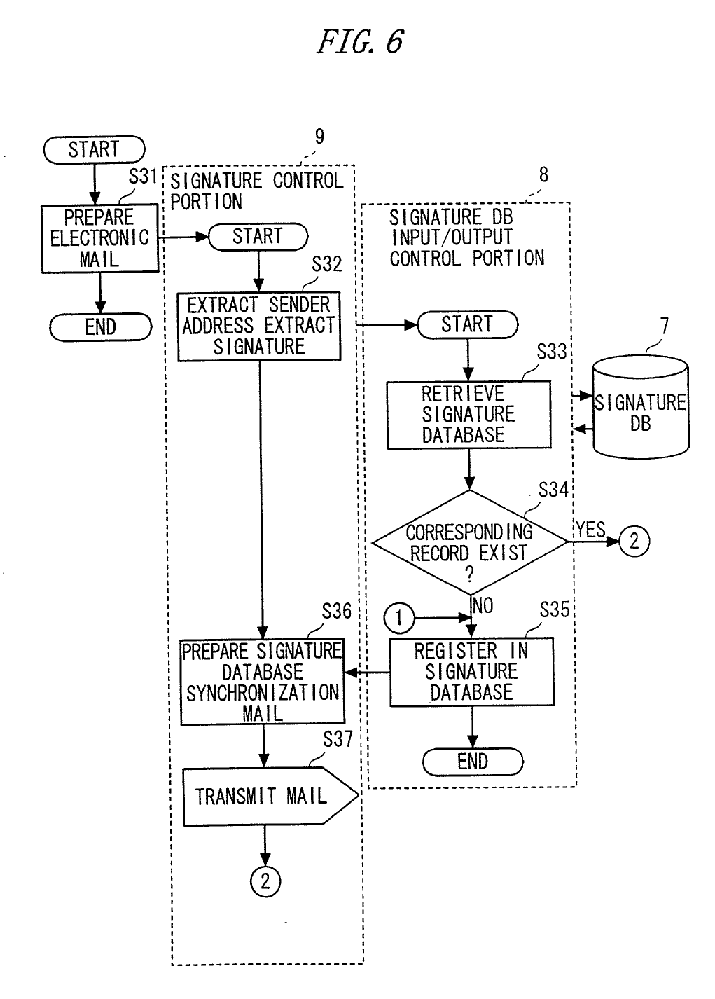

The input/output control portion 8, when finding a corresponding record (S14; Y), takes out a signature ID included in the record (S15). In this way, the input/output control portion 8 reads out a signature ID corresponding to a signature <corresponding to the identification information reading out means>. The input/output control portion 8 transfers the read out signature ID to the control portion 9. Further, if a corresponding record is not found in S14, the processing moves to S35 shown in FIG. 6.

Then, the control portion 9 deletes the signature from the mail A (S16) and gives the signature ID (SIGID=086C) to a place where the signature was located (S17). In this way, the control portion 9 prepares a mail A′ with the signature of the mail A converted to the signature ID by processing of S12, S16 and S17 (corresponding to the converting means). Since the signature ID is formed such that its size is smaller than that of the signature itself, the size of the mail A′ is smaller than that of the mail A. Thereafter, the control portion 9 transmits the mail A′ to the mail server 3 (S18, <corresponding to the transmitting means>).

Then, the mail A′ is received by the mail server 4 through the mail server 3 and the network 5. The mail server 4 is provided with a storage apparatus (an accumulation apparatus) of a mail (not shown), and a mail box corresponding to an electronic mail address of a receiver of the mail client 2 is prepared in the storage apparatus. The mail A′ is stored in the mail box.

(Procedures in a Receiving Side)

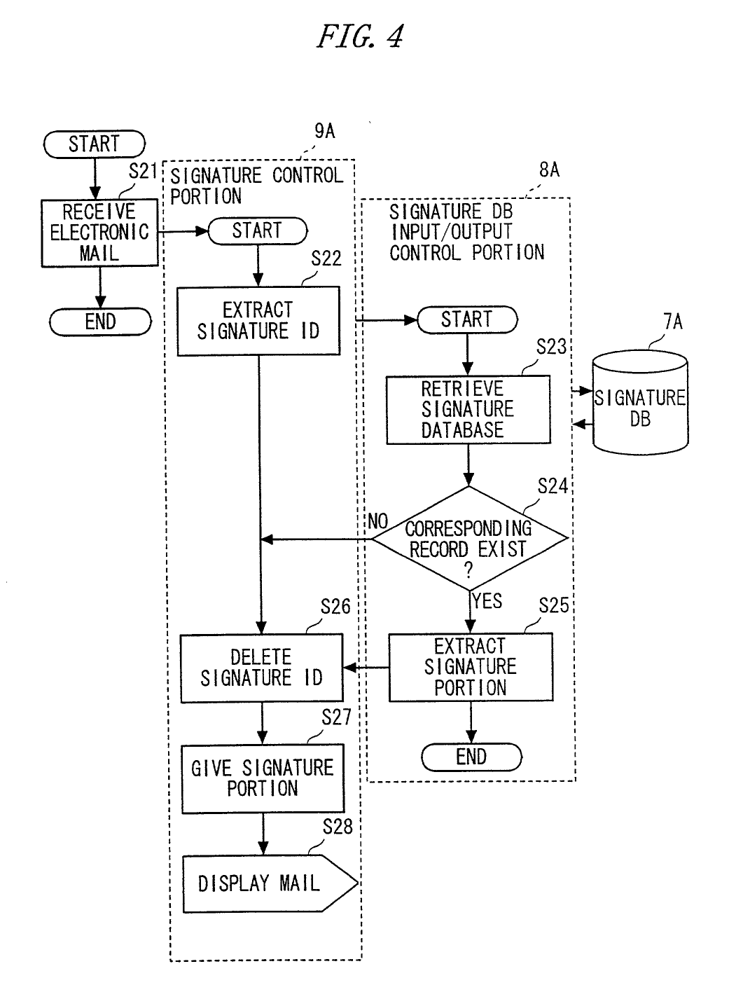

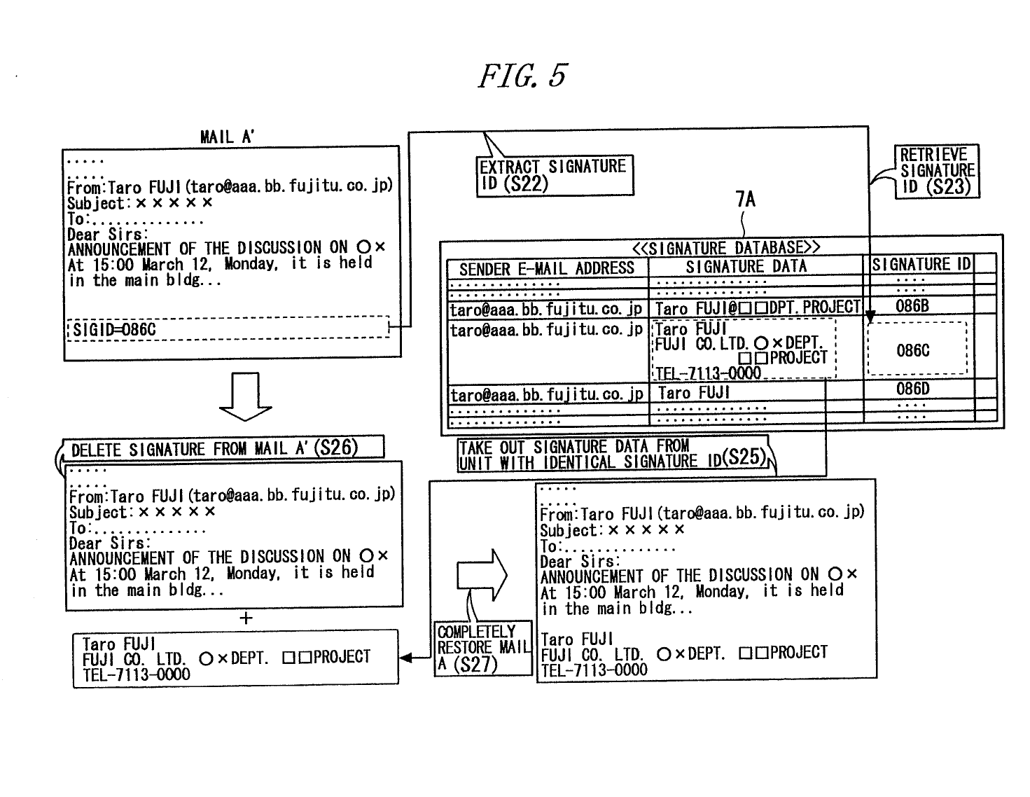

Procedures in a receiving side will now be described with reference to FIGS. 4 and 5. FIG. 4 is a flow chart describing operations in the receiving side (in this example, the mail client 2), and FIG. 5 is an explanatory view of the operations in the receiving side.

First, the mail client 2 receives a mail (S21). That is, a user of the mail client 2 (a receiver of the mail A), when referring to the mail A, operates the mail client 2 and inputs a download instruction of the mail A.

Then, a receiving request of the mail A is transmitted from the mail client 2 to the mail server 4. The mail server 4, upon receiving the receiving request, takes out the mail A′ from the mail box and transmits it to the mail client 2. The mail client 2 receives the mail A′ transmitted from the mail server 4 <corresponding to the receiving means>. The mail A′ is given to the control portion 9A.

The control portion 9A is activated by receiving the mail A′, extracts the signature ID from the mail A′ and gives it to the input/output control portion 8A (S22). Then, the input/output control portion 8A is activated, and retrieves through the DB 7A using the signature ID <corresponding to the second storing means> (S23).

The input/output control portion 8A, when finding a record corresponding to the signature ID (S24; Y), takes out the signature data included in the record (S25). In this way, the input/output control portion 8A reads out the signature data corresponding to the signature ID from the DB 7A <corresponding to the signature reading out means>.

The read out signature data is the data of the same signature as the signature deleted from the mail A in the mail client 1. This signature data is given to the control portion 9A. Further, if a corresponding signature is not found (S24; N), the processing moves to S26.

Then, the control portion 9A deletes the signature ID from the mail A′ (S26). The control portion 9A successively inserts (gives) a signature based on the signature data received from the input/output control portion 8 in the part where the signature ID was given (S27) In this way, the control portion 9A restores the mail A by converting the signature ID in the mail A′ to the signature by the processing of S22, S26 and S27 <corresponding to the restoring means>.

Thereafter, the control portion 9A displays the restored mail A on a display apparatus (not shown) of the mail client 2 (S28). In this way, all pieces of information of the mail that the sender of the mail A wishes to communicate to the receiver are communicated to the receiver.

(Synchronization of the Signature Database)

As described above, the electronic mail system in accordance with the present invention is based on the premise that the DB 7 and the DB7A are synchronized. Thus, the DB7 and the DB 7A are synchronized by the following processing.

(First Synchronization Processing)

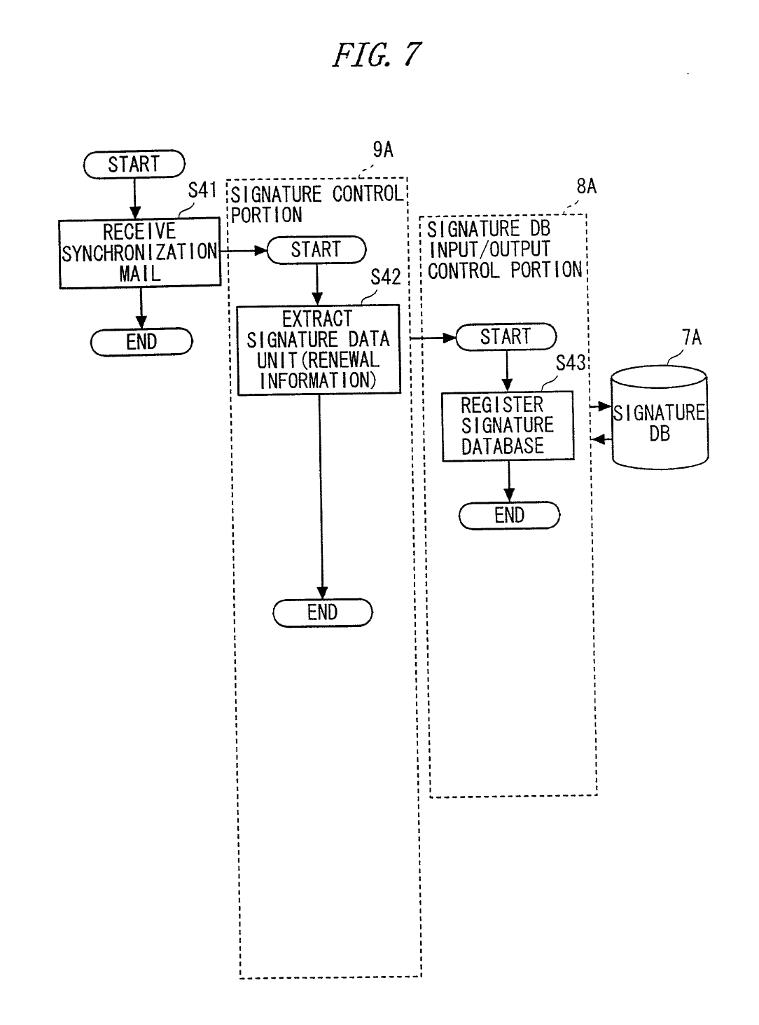

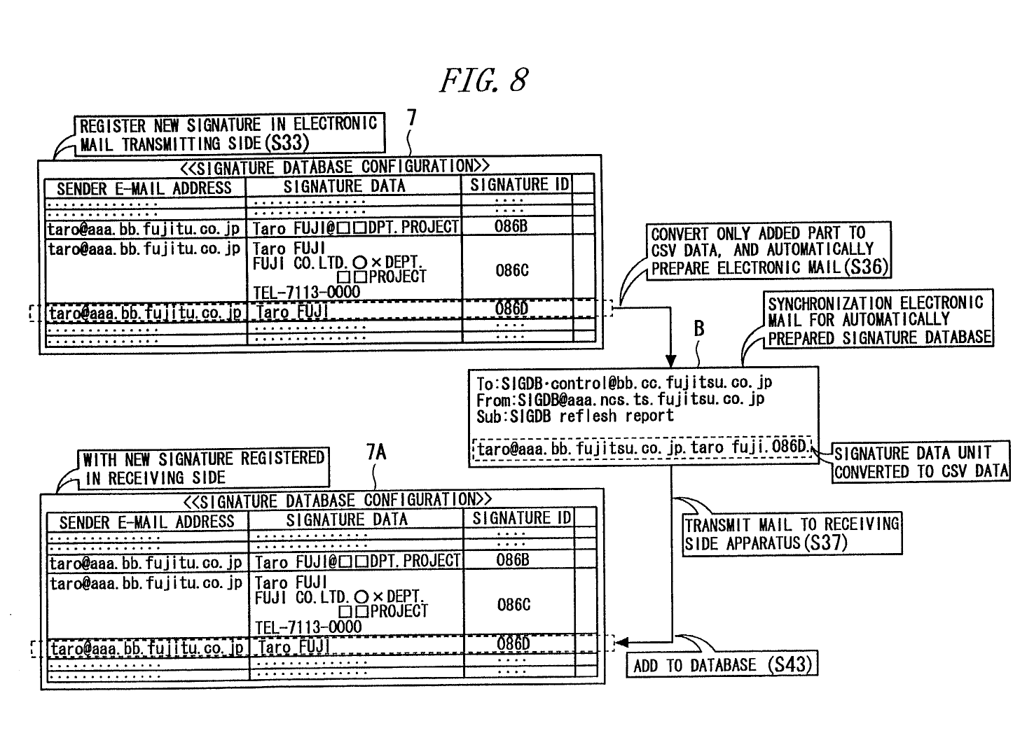

FIG. 6 is a flow chart showing first synchronization processing in the transmission apparatus, FIG. 7 is a flow chart showing first synchronization processing in the receipt apparatus, and FIG. 8 is an explanatory view of operations of the first synchronization processing. Here, as in the foregoing, the case in which the mail client 1 is the transmitting side (the transmission apparatus) and the mail client 2 is the receiving side (the receipt apparatus) is described.

In FIG. 6, since processing of S31 through S33 is the same as the processing of S11 through S13 shown in FIG. 2, description is omitted. In S34, if a record corresponding to the sender address and the signature data is not found as a result of the retrieval of the DB 7 executed in S33 (S34; N), the processing moves to S35, and if the record is found (S34, Y), the processing moves to S15 shown in FIG. 2.

In S35, the input/output control portion 8 prepares a record with a predetermined signature ID being allocated to the sender address and the signature data extracted in S32, and registers it anew in the DB 7. The input/output control portion 8 gives contents of the record recorded anew (a sender mail address, a signature (signature data) and a signature ID) to the control portion 9 as renewal information <corresponding to the extracting means>.

Then, the control portion 9 automatically prepares a signature database synchronization mail (a synchronization mail) B (S36). The synchronization mail B is an electronic mail for synchronization (for renewal) of the DB 7 of the receipt apparatus.

For example, the control portion 9 prepares an electronic mail in accordance with a CSV format (Comma Separated Value format) including a sender address, a signature and a signature ID (a signature data unit: renewal information) as a synchronization mail.

The CSV format is one of the formats for recording data in a file, with which data in one record is separated by comma (,) and arranged in a row (reference “2000-'01 version, Latest Personal Computer Term Dictionary” published by Gijutsu-Hyoron Co., Ltd., 11^{th} edition, 2^{nd} printing, published on Mar. 15, 2000). The CSV format is generally used for exchange of data between databases of different structures.

In the example shown in FIG. 8, a signature data unit “taro@aaa.bb.fujitsu.co.jp (a sender address) Fuji Taro (a signature), 086D (a signature ID)”, which is converted to a CSV format, is shown as renewal information with the sender address, the signature and the signature ID represented as separated by commas.

Thereafter, the control portion 9 transmits the prepared synchronization mail B to the receipt apparatus (the mail client 2) (S37). The synchronization mail B is relayed by the mail server 3, received by the mail server 4 through the network 5, and stored in a corresponding mail box.

Thereafter, as shown in FIG. 7, by the mail client 2 sending a receiving request of the synchronization mail B to the mail server 4, the synchronization mail B is taken out from the mail box of the mail server 4, and is given to the mail client 2.

When the mail client 2 receives the synchronization mail B (S41), the synchronization mail B is given to the control portion 9A. Then, the control portion 9A is activated, extracts the signature data unit (renewal information) from the synchronization mail B (S42), and gives it to the input/output control portion 8A.

Then, the input/output control portion 8A is activated, and registers anew contents of the signature data unit (the sender address, the signature, the signature ID) in the DB 7A (S43). In this way, the DB7 of the transmission apparatus (the mail client 1) and the DB 7A of the receipt apparatus (the mail client 2) are synchronized.

Thereafter, as shown in FIG. 6, in the transmission apparatus (the mail client 1), since the processing returns to S15 shown in FIG. 2 after the processing of S37, operations similar to those shown in FIGS. 2 through 5 are performed.

(Second Synchronization Processing)

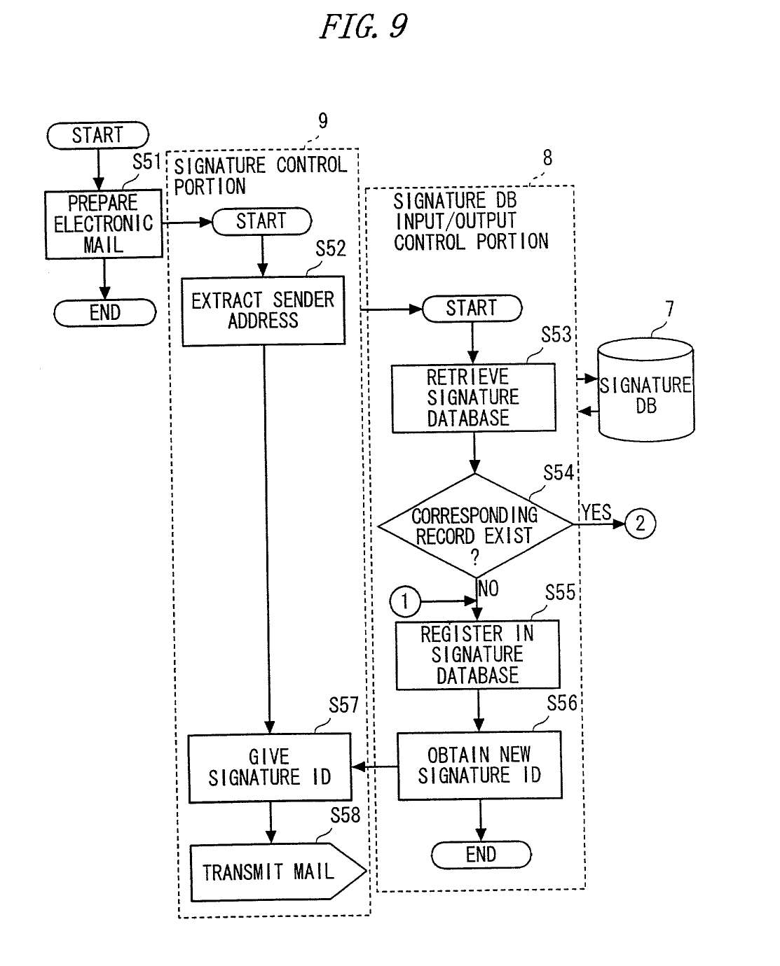

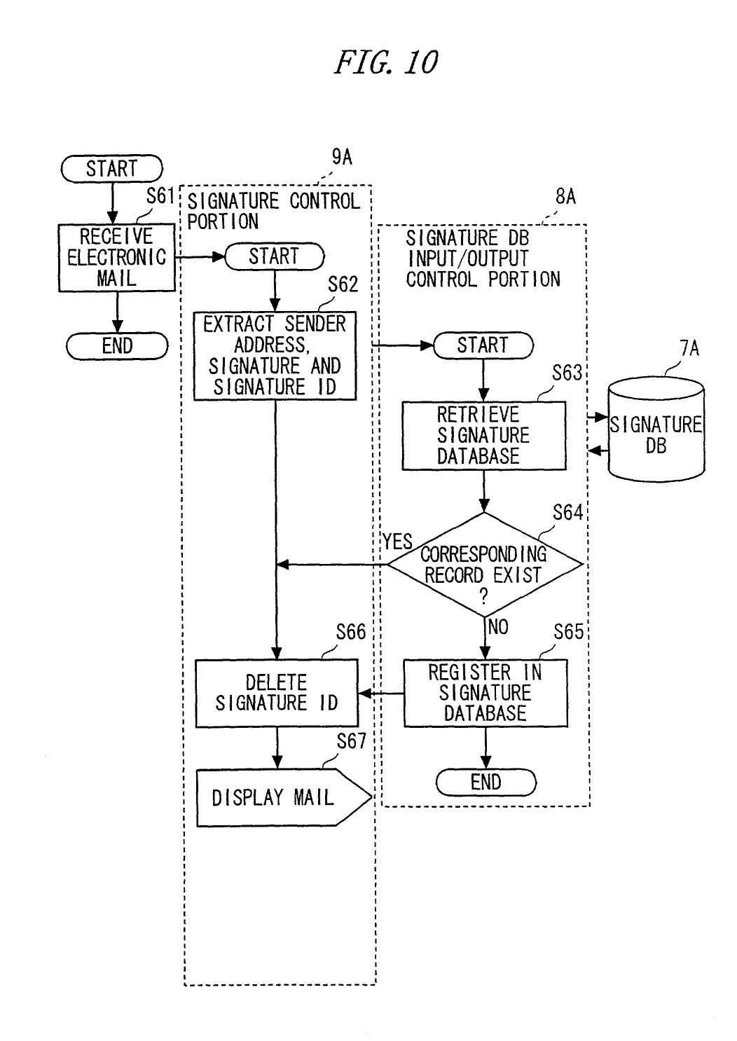

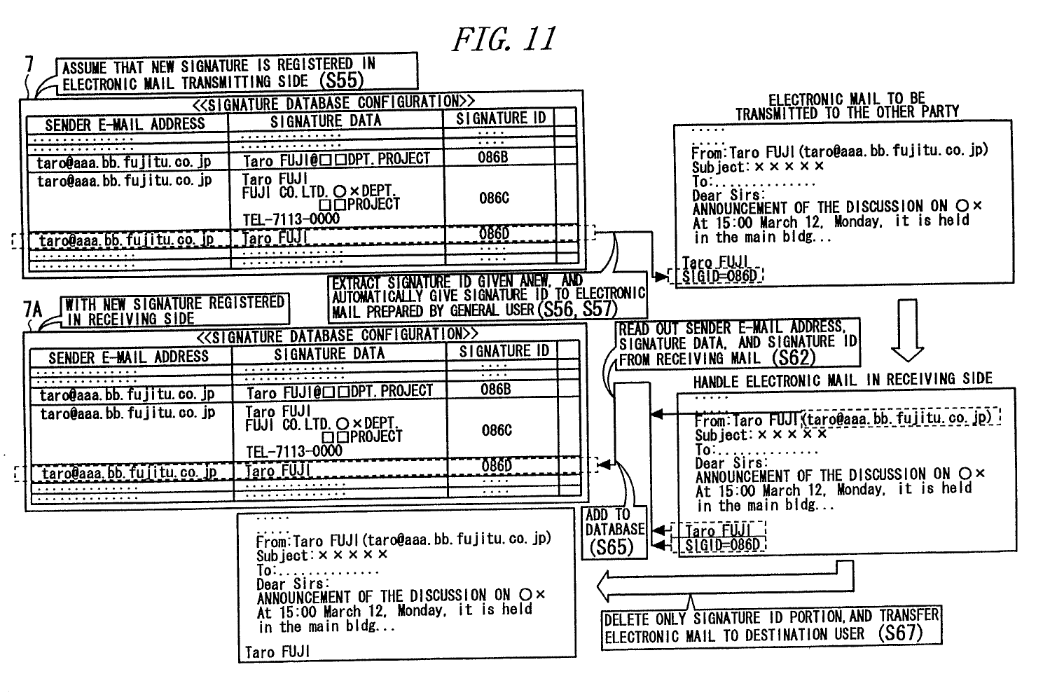

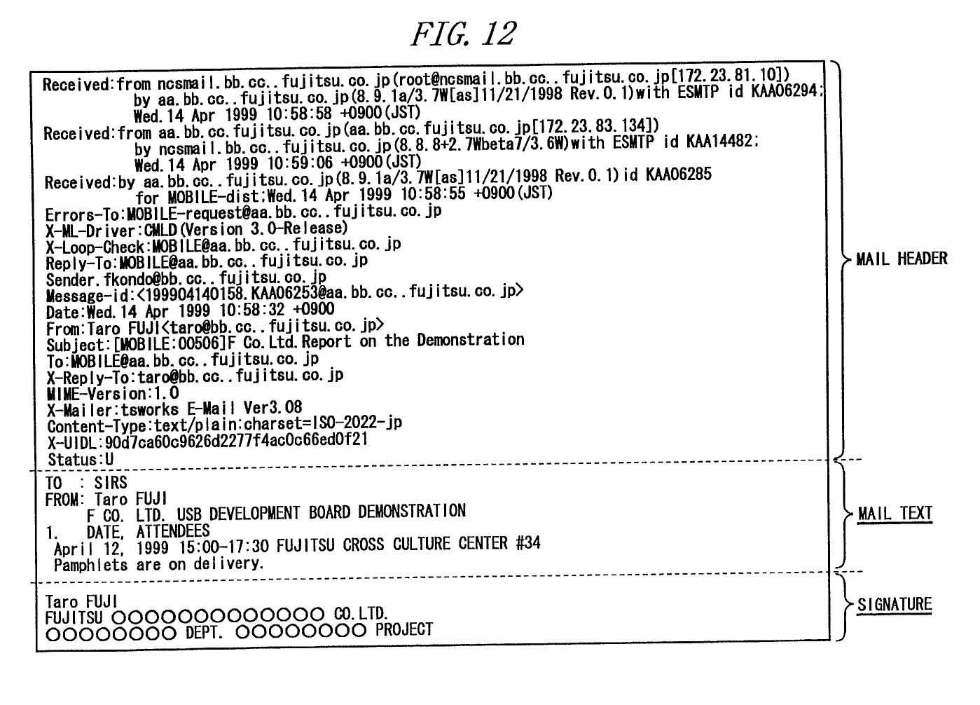

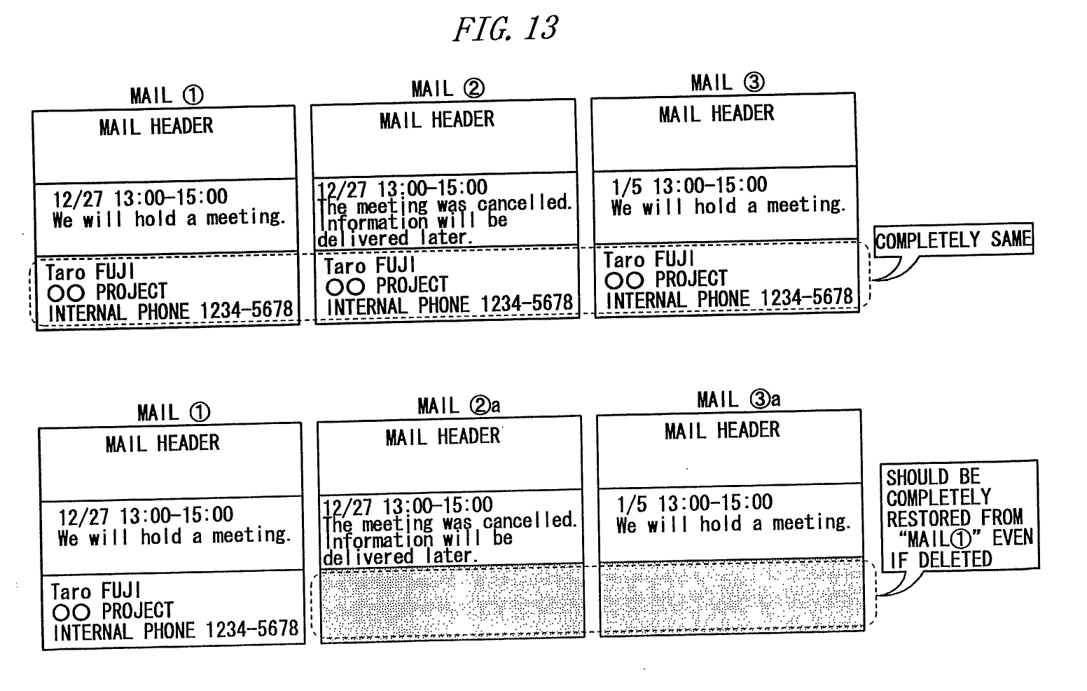

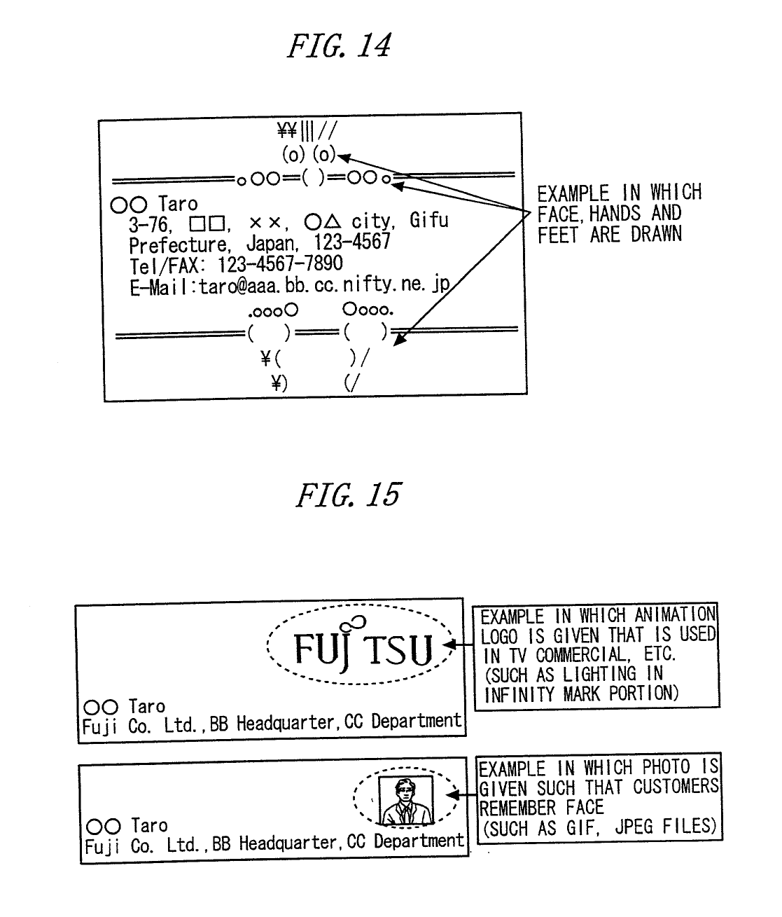

Second synchronization processing described below may be applied to the present invention instead of the above-mentioned first synchronization processing. FIG. 9 is a flow chart showing second synchronization processing in the transmission apparatus, FIG. 10 is a flow chart showing second synchronization processing in the receipt apparatus, and FIG. 11 is an explanatory view of operations in the second synchronization processing. Here, as in the foregoing, the case in which the mail client 1 is the transmitting side (the transmission apparatus) and the mail client 2 is the receiving side (the receipt apparatus) is described.

In FIG. 9, since processing of S51 through S55 is the same as the processing of S31 through S35 shown in FIG. 6, description is omitted. In S56, the input/output control portion 8 of the mail client 1 obtains a signature ID in a record registered anew in the DB 7 (a new signature ID) as renewal information, and gives it to the control portion 9 <corresponding to the extracting means).

Then, the control portion 9 gives (inserts) the new signature ID after a signature of a mail that is an object of transmission (S57: see FIG. 11). The control portion 9 then transmits the mail to which the signature ID is given (S58). The mail is relayed by the mail server 3, received by the mail server 4 through the network 5, and stored in a corresponding mailbox.

Thereafter, as shown in FIG. 10, by the mail client 2 sending a receiving request of the mail to which the signature ID is given to the mail server 4, a corresponding mail is taken out from the mail box of the mail server 4, and is given to the mail client 2.

When the mail client 2 receives the mail (S61), the mail is given to the control portion 9A. Then, the control portion 9A is activated, extracts the sender address from the mail header, at the same time extracts the signature itself and the signature ID from the storing portion of the signature (S62), and gives it to the input/output control portion 8A.

Then, the input/output control portion 8A is activated, and retrieves through the DB 7A using the sender address, the signature and the signature ID received from the control portion 9A (S63) At this time, if a record including the sender address, the signature and the signature ID does not exist in the DB 7A (S64; N), the input/output control portion 8a registers anew a record including the sender address, the signature and the signature ID in the DB 7A (S65). In this way, the DB 7 of the transmission apparatus (the mail client 1) and the DB 7A of the receipt apparatus (the mail client 2) are synchronized. On the other hand, in S64, if the corresponding record is accumulated in the DB 7A (S64; Y), the processing moves to S66.

Thereafter, in S66, the control portion 9A deletes the signature ID from the mail, and displays a mail with the signature ID deleted on the display apparatus of the mail client 2 (S67)

Further, as a method for synchronizing the DB 7 and the DB 7A, there is a method for registering a new record (a sender address, a signature and a signature ID) by manually inputting each of the DBs 7 and 7A, which can be adopted.

Moreover, since the mail client 1 and the mail client 2 have the same configuration, the mail client 2 can function as a transmission apparatus and the mail client 1 can function as a receipt apparatus. In this case as well, operations substantially similar to those shown in the above-mentioned FIGS. 2 through 10 are performed. Therefore, the DB 7 and the DB 7A of each of the mail clients 1 and 2 function as the first storing means and the second storing means of the present invention.

<Operations of the Embodiment>

In accordance with this embodiment, the transmitting side (the mail client 1) of the mail A transmits the mail A′ whose size is reduced by replacing the signature with the specific code (the signature ID). On the other hand, the receiving side (the mail client 2) of the mail retrieves through the DB 7A based on the signature ID in the mail A′, takes out a corresponding signature, and pastes it in the signature portion of the mail A′. In this way, the mail A′ is restored to its original form (the mail A).

Therefore, in accordance with this embodiment, suppression of the band of the transmission route (the transmission band) between the mail client 1 and the mail client 2 can be reduced, and at the same time, decrease of area of use in an accumulation apparatus (a storage apparatus: for example, a hard disk) in each of the mail servers 3 and 4 (control of suppression of a storage area of the storage apparatus) can be realized. Moreover, all contents transmitted by the sender can be communicated to the receiver.

Particularly effective field for utilizing the present invention is a case in which electronic mails with the same contents are transmitted to a multiplicity of transmission destinations (destinations) using “a mailing list”. Destinations of an electronic mail do not necessarily have different mail servers in all the transmission destinations. Therefore, it is possible that a plurality of mails including mail texts and signatures with completely the same contents are accumulated in the same storage apparatuses of the mail server. In such a case, if the present invention is applied, since the signature portion of each mail is converted to the signature ID, the size of each mail is small and suppression of the storage area can be particularly controlled.

<Example of Modification>

The electronic mail system in accordance with this embodiment can be modified as described below. That is, in the above-mentioned embodiment, a configuration is adopted in which each of the mail clients 1 and 2 is provided with the DB 7 (7A) the input/output control portion 8 (8A) and the control portion 9 (9A). In this embodiment, there is an advantage that, since a user uses a mail service of a provider, the electronic mail system can be applied to a case in which a mail server side is not allowed to perform arbitrary setting.

In stead of the above-mentioned configuration, another configuration may be adopted in which the mail server 3 is provided with the DB 7, the input/output control portion 8 and the control portion 9, and the mail server 4 is provided with the DB 7A, the input/output control portion 8A and the control portion 9A. That is, a mail server may be made to execute the processing of converting a signature to a signature ID, and the processing of restoring a mail based on a signature ID. More specifically, a mail server relaying a mail is made to function as the transmission apparatus in accordance with the present invention, and a mail server corresponding to a destination of a mail is made to function as a receipt apparatus in accordance with the present invention.

Naturally, a mail server may be made to have the functions of both the transmission apparatus and the reception apparatus of the present invention. In this way, a terminal at a user side and an application (a mail client) do not need to be conscious of the processing in accordance with the present invention, and have an advantage that a service can be uniformly provided to many users.

Alternatively, the present invention can adopt a form in which the transmission apparatus of a mail is a mail server and the reception apparatus is a mail client, or a form in which the transmission apparatus of a mail is a mail client and the reception apparatus is a mail server.

In addition, an unnecessary record can be deleted from each of the DBs 7 and 7A by exchanging information of records relating to deletion between the transmission and the reception apparatuses by a method substantially similar to the first synchronization processing and the second synchronization processing.

Further, in the management of each of the DBs 7 and 7A, a configuration may be adopted in which, by recording a final utilization date and time for each record, a signature that is not utilized for a predetermined period (for example, one month) is deleted from each of the DBs 7 and 7A, as being of no value in using again. In this case, determination on deletion of a record is executed by independent decisions in the transmission apparatus and the reception apparatus respectively.

This invention being thus described, it will be obvious that same may be varied in various ways. Such variations are not to be regarded as departure from the spirit and scope of the invention, and all such modifications would be obvious for one skilled in the art intended to be included within the scope of the following claims.

What is claimed is:

1. An electronic mail system comprising:
a transmission apparatus including;
first storing means for holding a signature of an electronic mail by associating it with identification information;
identification information reading out means for reading out from said first storing means identification information corresponding to a signature included in an electronic mail to be transmitted;
converting means for converting the signature of said electronic mail to the identification information read out by the identification information reading out means; and
transmitting means for transmitting said electronic mail with its signature part being converted to the identification information by said converting means to its destination; and
a reception apparatus including;
second storing means for holding a signature of an electronic mail by associating it with identification information;
receiving means for receiving an electronic mail transmitted from said transmission apparatus;
signature reading out means for reading out from said second storing means a signature corresponding to the identification information included in said electronic mail received by said receiving means; and
restoring means for converting the identification information included in the electronic mail to the signature read out by the signature reading out means.

2. An electronic mail system according to claim 1 wherein;
said first storing means and said second storing means hold a signature and identification information corresponding to the signature by associating them with a sender's mail address of an electronic mail.

3. An electronic mail system according to claim 1 or 2 wherein;
said transmission apparatus further includes extracting means for, when contents held by said first storing means are renewed, extracting information concerning the renewal as renewal information, and transmits said renewal information; and
said reception apparatus further includes renewing means for, when said receiving means receives said renewal information, renewing contents held by said second storing means in accordance with said renewal information.

4. An electronic mail system according to claim 3 wherein;
said transmitting means transmits an electronic mail having renewal information including a signature registered anew in said first storing means and identification information allocated to this signature, and said renewing means renews contents held by said second storing means in accordance with said renewal information included in said electronic mail received by said receiving means.

5. An electronic mail system according to claim 4 wherein;
said electronic mail is an electronic mail for renewing the contents of said second storing means.

6. An electronic mail system according to claim 4 wherein;
said electronic mail is an electronic mail with a signature registered anew in said first storing means and identification information corresponding to the signature being added to an electronic mail to be transmitted to said reception apparatus.

7. A transmission apparatus of an electronic mail comprising:
storing means for holding a signature of an electronic mail by associating it with identification information;
identification information reading out means for reading out from said storing means identification information corresponding to a signature included in an electronic mail to be transmitted;
converting means for converting the signature of said electronic mail to the identification information read out by the identification information reading out means; and
transmitting means for transmitting said electronic mail with its signature part being converted to the identification information by said converting means to its destination.

8. A reception apparatus of an electronic mail comprising:
storing means for holding a signature of an electronic mail by associating it with identification information;
receiving means for receiving an electronic mail transmitted by said transmission apparatus;
signature reading out means for, if identification information of a signature is included in said electronic mail received by said receiving means, reading out a signature corresponding to the identification information from said storing means; and
restoring means for converting the identification information included in said electronic mail to the signature read out by said signature reading out means.
